(19) United States
(12) Patent Application Publication
(10) Pub. No.: US 2021/0383368 A1
(43) Pub. Date: Dec. 9, 2021

(54) SYSTEM AND METHOD FOR MANAGING FUND TRANSFERS

(71) Applicant: Tariq Jalil, Venice, CA (US)

(72) Inventor: Tariq Jalil, Venice, CA (US)

(21) Appl. No.: 17/411,010

(22) Filed: Aug. 24, 2021

Related U.S. Application Data
(63) Continuation of application No. 16/935,162, filed on Jul. 21, 2020.
(60) Provisional application No. 62/877,161, filed on Jul. 22, 2019.

(51) Int. Cl. G06Q 20/36; G06Q 20/10

(52) U.S. Cl. CPC G06Q 20/3678; G06Q 20/102

(57) ABSTRACT

The present disclosure provides a system and method for managing fund transfer. The system has one or more processors and a memory coupled to the processors and enables a user to link financial accounts to a user account, verify KYC documents before linking the financial accounts, and generates a unique code comprising details of the user account to safely transfer funds such as cryptocurrency. The system is further configured to executed at least one financial service request utilizing the unique code. A method for fund transfer and a system architecture for data routing for fund transfer is also provided herein

### CROSS-REFERENCE TO RELATED APPLICATIONS

The present Utility Application is a Continuation Application of U.S. non-provisional patent application Ser. No. 16/935,162 filed Jul. 21, 2020, entitled System and Method for Managing Fund Transfers, which itself claims the benefit of U.S. Provisional Application No. 62/877,161 entitled System and Method for Managing Fund Transfers, filed on Jul. 22, 2019, the entirety of all being incorporated herein by reference for all purposes.

### FIELD OF THE INVENTION

The present invention generally relates to a system and method for managing fund transfers. More specifically, the present invention relates to a system and method for a Peer-to-Peer (P2P) and Peer-to-Merchant (P2M) payment mobile application to facilitate exchange or transfer of funds from one user to another user, particularly when one of the user's is a merchant or appears in media.

### BACKGROUND

The trend towards use of non-cash transactions and settlement began in daily life during the 1990s, when electronic banking became common. By 2010 digital payment methods were widespread in many countries, with examples including intermediaries such as PayPal®, digital wallet systems operated by companies like Apple®, contactless and NFC payments by electronic card or smartphone, and electronic bills and banking, all in widespread use.

More recently, digital payments companies such as Venmo® and Square® allows individuals to make direct payments to other individuals without having cash accessible if the former, and allow primarily small businesses to receive payments from their clients if the latter.

Indeed, a study by the United States User Consumer Survey Study found that 75% of respondents preferred a credit or debit card as their payment method while only 11% of respondents preferred cash, and it is estimated that Venmo® has over 10 million active users a month.

However, while these P2P payment systems allow users to interact in a variety of ways, conventional digital systems still have a variety of problems. For example, in order to interact with others, many digital systems require users to first identify and/or digitally connect with a that third party. As an example, to send a payment to another individual, the users must search and identify their payee, which involves asking for, and manually entering or searching for identifying information (e.g., a phone number, e-mail address, or bank account information) or searching through a list of users provided by the digital system. This search perpetuates user error. Identifying other parties utilizing such lists is often unreliable because a user incorrectly selects a different user with a similar name and inconvenient.

Furthermore, current payment systems do not have the universality that users have come to appreciate in other spaces. As an example, whilst a P2P payment system may work well for P2P payments, it is not convenient for consumer to merchant payments due to expensive hardware and other factors.

QR codes, originally designed for tracking parts in vehicle manufacturing, have become ubiquitous on account of the wide range of applications that have been found for them, including advertising, commercial tracking, entertainment and transport ticketing, product-loyalty marketing (e.g., QR codes used for coupons that can be redeemed using a mobile app for QR code decoding), and in-store product labeling as well as on account of their fast readability and greater storage capacity compared to the older UPC bar codes. Many applications (apps) are now available enabling, for example, a smartphone to be used as a QR code scanner that displays the QR code and converts it to some useful form (such as a standard uniform resource locator (URL) for a website, so that a user does not have to type the URL into a web browser to go to the site).

Whilst QR codes are veritable, cost effective and trackable, problems may arise because of the lack of native support and risk tolerance.

Therefore, there is a need for a system and method for managing fund transfer that alleviates one or more problems discussed above.

### SUMMARY OF THE INVENTION

The following summary of the invention is provided in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

To achieve the foregoing and other aspects and in accordance with the purpose of the invention, a system and method for managing fund transfers is provided.

The present system provides the ability exchange or transfer funds (e.g., cryptocurrency) from one user to another using a unique code such as QR code or a unique ID from a smart device.

The system comprises one or more processors and a memory coupled to the processors. The memory stores program instructions executable by the processors to implement a fund transfer management platform.

In embodiments, the system is organized as a mobile application for a smart phone, and enables a user to create a user account by registering one or more confidential and secure credentials. The system is enables the user to link a plurality of financial accounts to the user account. The system automatically verifies KYC documents before linking the financial accounts, and enables the user to create one or more client accounts and link those with a plurality of financial account, and further, enables the user to select at least one financial service request, wherein the financial service request comprises a money transfer service. The unique code may comprise comprising details of the user account, wherein the code is at least one of unique ID or a QR code that is verifiable user to user or user to institution.

In embodiments, the system is further configured to executed at least one financial service request utilizing the unique code and enable the user to manage one or more accounts created and linked by the user. In one embodiment, the user is at least one of a fund transferor or fund transferee. The financial service may comprise a scan and payment request, send payment request and/or accept payment request. The fund transferee is at least one of merchant, a person in media such as a social influencer or a merchant or person on YouTube® for example. In embodiments, the identifier (e.g., QR code) may appear on the media itself or on the person in the media (i.e., on a shirt for the person in the media).

According to the present disclosure, a method for managing fund transfer is provided. The method comprises a step of enabling, at the processor, via a registration module, a user to create a user account by registering one or more credentials. The method further comprises a step of enabling, at the processor, via an account linking module, the user to link a plurality of financial accounts to the user account. The method further comprises a step of enabling, at the processor, via an account creation module, the user to create one or more client account and link with the plurality of financial account.

The method further comprises a step of enabling, at the processor, a service selection module, the user to select at least one financial service request, wherein the financial service request comprises a money transfer service. The method further comprises a step of generating, at the processor, via a unique code generation module, a unique code comprising details of the user account, wherein the code is at least one of unique ID, QR code, and link. The method further comprises a step of executing, at the processor, via a financial service execution module, at least one financial service request utilizing the unique code. The method further comprises a step of verifying, at the processor, via the account linking module, KYC documents before linking the financial accounts. The method further comprises a step of managing, at the processor, via an account management module, one or more accounts created and linked by the user.

Advantages of the system and methods used herein allow to manage fund transfers across a plurality of different verticals including but limited to P2P, consumer to merchant, consumer to institution and institution to institution using a unique identifier such as a QR code.

Advantages of the system and methods used herein comprise a peer-to-peer (P2P) payment application and it allows users to quickly and easily pay a tip, donate money and send a payment to a friend by simply scanning a QR code or entering a user's code. It eliminates the need to carry and pay with cash. Further, the present system offers an easy-to-use mobile app that focuses on speed and simplicity. The present system may be incorporated in any digital device via mobile application, and work on a plurality of servers and load balancers to ensure speed and efficiency of the system. The system and method according to the present system, will provide the ability for users to: a) Register and login, b) Invite friends c) Link External Accounts d) Scan & Pay e) Send Payment f) Accept Payment g) Request Payment h) Accept Payment Request i) Create & customize QR Code j) Display, scan and share QR Code k) Print QR Code l) Unique User Code, and m) view Transaction History.

Other objects, features and advantages of the present system will become apparent from the following detailed description. It should be understood, however, that the detailed description and the specific examples, while indicating specific embodiments of the system, are given by way of illustration only, since various changes and modifications within the spirit and scope of the system will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 is a schematic block diagram illustrating one or more entities involved in exchange or transfer of funds according to an embodiment of the present system.

FIG. 2 is a schematic block diagram illustrating an environment of a fund transfer management system according to an embodiment of the present system.

FIG. 3 is a schematic block diagram illustrating a fund transfer management server according to an embodiment of the present system.

FIG. 4 illustrates a flowchart of a method for managing fund transfer according to an embodiment of the present system.

FIG. 5 illustrates a use case model of physical merchant utilizing the system, according to an embodiment of the present system.

FIG. 6 illustrates a use case model of online merchant using unique link for fund transfer, according to an embodiment of the present system.

FIG. 7 illustrates a use case model of online merchant using unique ID for fund transfer, according to an embodiment of the present system.

FIG. 8 illustrates a use case model of content creator using computing device such as computer for fund transfer, according to an embodiment of the present system.

FIG. 9 illustrates a use case model of content creator using computing devices such as computer and mobile device for fund transfer, according to an embodiment of the present system.

FIG. 10 illustrates a use case model of content creator using computing devices such as mobile device for fund transfer, according to an embodiment of the present system.

FIG. 11 illustrates a use case model of peer-to-peer fund request, according to an embodiment of the present system.

FIG. 12 illustrates a use case model of peer-to-peer fund transfer request, according to an embodiment of the present system.

FIG. 13 illustrates a block diagram of top-level view of financial platform of the fund transfer system, according to an embodiment of the present system.

FIG. 14 illustrates a method of linking financial account, according to an embodiment of the present system.

FIG. 15 illustrates a method of verification of user identity, according to an embodiment of the present system.

FIG. 16 illustrates a method of linking financial account, according to an embodiment of the present system.

FIG. 17 illustrates a method of linking financial account such as debit card, according to an embodiment of the present system.

FIG. 18 illustrates a method of transferring funds, according to an embodiment of the present system.

FIG. 19 illustrates a method of checking availability of fund, according to an embodiment of the present system.

FIG. 20 illustrates a method of checking availability of fund and transferring funds from an external account, according to an embodiment of the present system.

FIG. 21 illustrates a method of transferring funds, according to another embodiment of the present system.

FIG. 22 illustrates a method of transferring funds from bank to bank, according to an embodiment of the present system.

FIG. 23 illustrates a method of requesting funds from bank to bank, according to an embodiment of the present system.

FIG. 24 illustrates a method of transferring funds from external account such as credit card, debit card to bank, according to an embodiment of the present system.

FIG. 25 illustrates a specialized system architecture diagram of a data routing scheme for exchange or transfer of funds according to an embodiment of the present system.

Other features, advantages, and aspects of the present invention will become more apparent and be more readily understood from the following detailed description, which should be read in conjunction with the accompanying drawings.

### DETAILED DESCRIPTION OF THE INVENTION

The present invention is best understood by reference to the detailed figures and description set forth herein.

It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

Reference will now be made in detail to various embodiments. Each example is provided by way of explanation and is not meant as a limitation and does not constitute a definition of all possible embodiments. The described embodiments are to be considered in all respects only as illustrative and not restrictive. For purposes of illustrating features of the embodiments, a simple example will now be introduced and referenced throughout the disclosure. Those skilled in the art will recognize that this example is illustrative and not limiting and is provided purely for explanatory purposes. An example of a computing system environment is disclosed. The computing system environment is not intended to suggest any limitation as to the scope of use or functionality of the system and method described herein. Neither should the computing environment be interpreted as having any dependency or requirement relating to any one or combination of components illustrated in the exemplary operating environment.

Embodiments of the disclosure are operational with numerous other general purposes or special purpose computing system environments or configurations. Examples of well-known computing systems, environments, and/or configurations that may be suitable for use with the systems and methods described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The embodiments of the disclosure may be described in the general context of computer-executable instructions, such as program modules, being executed by a computer. Generally, program modules include routines, programs, objects, components, data structures, etc. that perform particular tasks or implement particular abstract data types. The systems and methods described herein may also be practiced in distributed computing environments where tasks are performed by remote processing devices that are linked through a communications network. In a distributed computing environment, program modules may be located in both local and remote computer storage media including memory unit or storage devices. Tasks performed by the programs and modules are described below and with the aid of figures. Those skilled in the art can implement the exemplary embodiments as processor executable instructions, which can be written on any form of a computer readable media in a corresponding computing environment according to this disclosure.

Components of computer may include, but are not limited to, a processing unit, a system memory, and a system bus that couple various system components including the system memory to the processing unit. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer comprises a variety of computer readable media. Computer readable media can be any available media that can be accessed by computer and comprises both volatile and non-volatile media, removable and non-removable media. By way of example, and not limitation, computer readable media may include computer storage media and communication media. Computer storage media comprises both volatile and non-volatile, removable and non-removable media implemented in any method or technology for storage of information such as computer readable instructions, data structures, program modules or other data. Computer storage media comprises, but not limited to, Random Access Memory (RAM), Read-Only Memory (ROM), Electrically Erasable Read-Only Memory (EEPROM), flash memory or other memory technology, Compact Disk Read-Only Optical Memory (CD-ROM), digital versatile disks (DVD) or other optical disk storage, magnetic cassettes, magnetic tape, magnetic disk storage or other magnetic storage devices, or any other medium which can be used to store the desired information and which can be accessed by computer.

As used herein, the term “media subject” may refer to any person or subject that appears in any type of media including but not limited to social media, online media (e.g., YouTube®), television media, and the like.

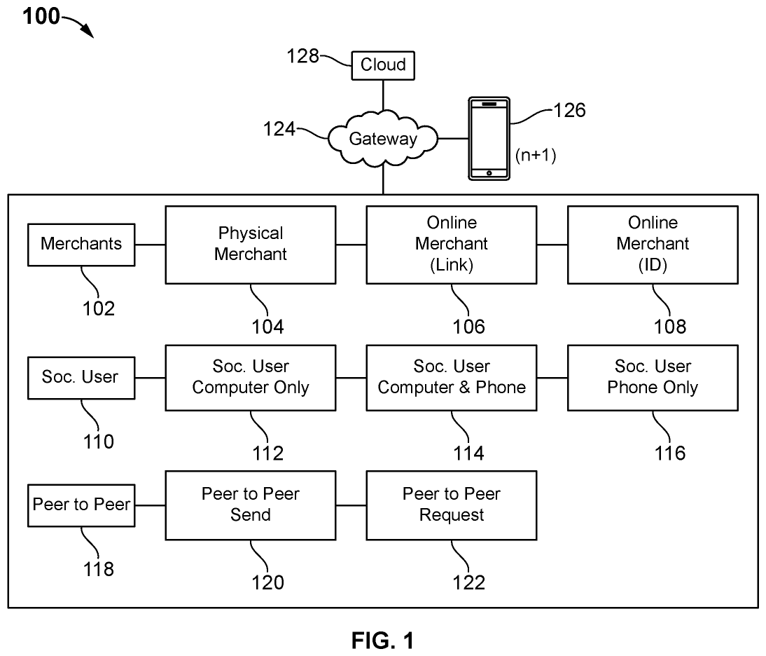

The present system discloses a system and method for managing fund transfers across a plurality of different verticals including but limited to P2P, consumer to merchant, consumer to institution and institution to institution using a unique identifier such as a QR code. Referring FIG. 1, a block diagram 100 is provided showing an ecosystem having a plurality of potential users and end-users connected to a network exchange a mobile application interface is shown. In this embodiment, the block diagram 100 shows the exchange or transfer of funds from one user to another. In one embodiment, the user is at least one of individual, entity, account, merchant 102, peer-to-peer 118 or media subject 110. The system is configured to use a unique code to enable exchange or transfer of funds, which comprises at least one of QR code, unique ID or link. The cloud 128 is provided to communicate and download the app and system architecture to the smartphone 126, via a gateway 124. In one embodiment, the merchants 102 include physical merchant 104, online merchant (link) 106 and online merchant (ID) 108. In one embodiment, the media subject 110 includes media subject computer 112, media subject computer and phone 114 and media subject phone 116. In one embodiment, peer to-peer 118 includes peer-to-peer send 120 and peer-to-peer request 122.

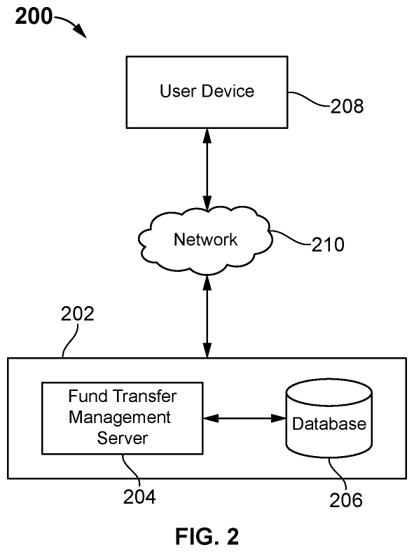

Referring to FIG. 2, the environment 200 comprises a fund transfer management system 202, a user device 208 associated with a user and a network 210. The system 202 comprises a fund transfer management server 204 and a database 206. The user device 208 is in communication with the server 204 via the network 210. In an embodiment, the user device 208 is a smartphone having a mobile application downloaded onto it which provides communication capabilities via network 210, which may be a could be Wi-Fi network, WiMax network, and wireless local area network. In one embodiment, the user could be at least one of individual, entity, account, merchant, or media subject.

In one embodiment, the database 206 may be accessible by the server 204. The database 206 may be integrated into the server 204 or separate from it. In some embodiments, the database 206 resides in the connected server 204 or in a cloud computing service. Regardless of location, the database 206 comprise a memory to store and organize certain data for use by the server 204. In some embodiments, the database stores plurality of user related information and a fund transfer algorithm. In one embodiment, the fund transfer server 204 is at least one of a general or special purpose computer.

In embodiments, the system 202 is configured to enable a user to create a user account by registering one or more credentials and enable the user to link a plurality of financial accounts to the user account. The system 202 is further configured to verify KYC documents before linking the financial accounts. The system 202 is further configured to enable the user to create one or more client account and link with the plurality of financial account. The system 202 enables the user to select at least one financial service request such as a fund transfer.

Still with reference to FIG. 2, the system 202 is further configured to generate a unique code comprising details of the user account, wherein the code is at least one of unique ID, QR code, and link. The system 202 is further configured to executed at least one financial service request utilizing the unique code, and the system is configured to generate the unique code. In embodiments, the system is configured to generate QR codes that are usable in media. The system 202 is further configured to enable the user to manage one or more accounts created and linked by the user. In one embodiment, the credentials include, but not limited to, first name, last name, email address, phone number and password. In one embodiment, the user is at least one of a fund transferor or fund transferee. In one embodiment, the financial service, comprises but is not limited to, scan and payment request, send payment request and accept payment request. In one embodiment, the fund transferee is at least one of merchant, media subject or individual. In other embodiments, when the system must recognize a QR code it did not generate itself (e.g., QR code in the media) the system 202 automatically detects, using the smartphone camera, if the QR code is not a payment, the system notify the user request permission to the QR code-directed website, website, application or UI of the merchant instead. Further, the system allows capturing QR code in media to pay the person or company in or controlling the media via fund or cryptocurrency deposit.

In operation, the system and platform functions create clients, properly identify clients automatically, and securely collect and tokenize their personal information. Securitization of the platform is accomplished by performing a full CIP (Customer Information Profile) verification. The system 202 further provides the automated ability to create, manage, and monitor financial accounts for users. The system 202 is further configured to receive funds into user accounts created by the system 202 of the present system using ACH, credit card, debit card or book transfer and send funds to and from user accounts using ACH, debit card or credit card. The system 202 enables the user to verify bank account and balance information using bank login as the authentication method. In this way, the system 202 enables to send fund or request fund from one user to another user in a way where each user may select the originating account from a group of accounts.

The system 202 enables the user to withdraw funds to his or her linked account whether that is a bank account or a payment network. The system 202 is configured to perform various administrative functions such as uploading daily reports and settling pending credit card transactions. The system 202 enables to register an individual, or client, on the fund transfer platform. When connected to the banking backend, this creates a client profile in the banking system. Creating the client is the first step to tokenizing external account information, such as a credit card number, or for opening a bank account for your user, collecting money into the account, and sending money to billers or other users. The system 202 enables the user to change the details of an already existing client and link a to multiple merchants. Further, while adding the client account, KYC validation is done using data such as first name, last name, address, email, mobile, DOB, social security number SSN and photo of driver's license or any combination thereof.

The system 202 is configured to send notification of the status of a client once their profile has been created in the fund transfer platform, i.e. backend bank to update the status of a client. The status could be unverified, receive, send and receive or locked. The system 202 is configured to enable a user to search for registered clients. In one embodiment, the system 202 is configured to enable a user to search for registered clients by their status and view respective information of the client. The system 202 also facilitates to cancel a linked client.

In operation, the system 202 is further configured to allow the user to link the client account to the external bank account. The system 202 is further configured to allow the user to manage the list of user account connected to the client account, which includes update, addition, deletion of data. The system 202 is further configured enable the user to check the balance information of the linked external account.

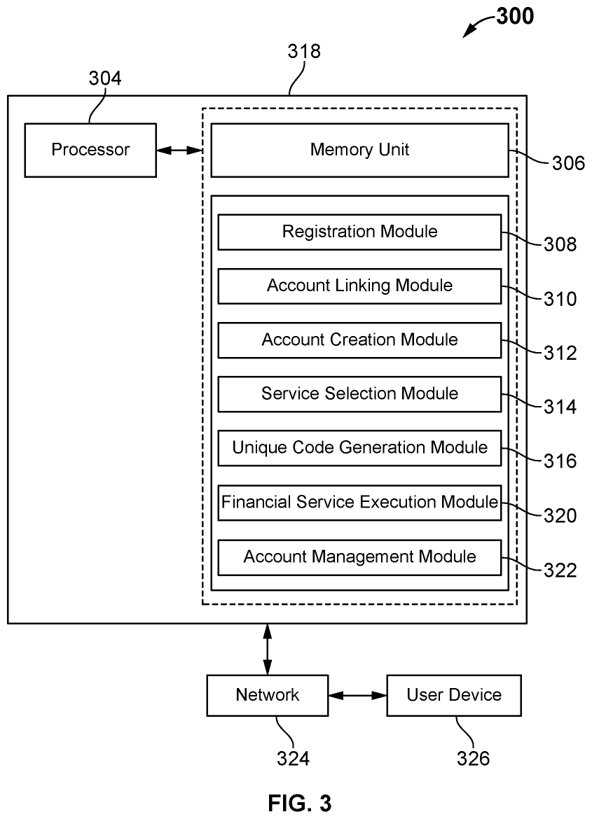

A block diagram 300 of the fund transfer management server 204 or 318 is detailly illustrated in FIG. 3. Referring to FIG. 3, the server 318 comprises a processor 304 and a memory unit 306. The memory unit 306 comprises a set of program modules. The set of program modules comprises a registration module 308, an account linking module 310, an account creation module 312, service selection module 314, a unique code generation module 316, a financial service execution module 320 and an account management module 322.

In one embodiment, the user accesses the server 318 utilizing a user device 322 via a network 324. In some embodiments, the user device 326 is at least anyone of a desktop, a laptop, a tablet, a mobile phone, mobile and/or handheld electronic devices, personnel digital assistants, smart phones, smart televisions, palm tops and phablets. The server 318 is in communication with a database, the database stores information related to user, user's financial account, client information, payee information, and fund transfer algorithm.

The registration module 308, executed by the processor 304, is configured to enable a user to create a user account by registering one or more credentials, via the user device 326, wherein the user device accesses the fund transfer management platform via the network 324. The account linking module 310, executed by the processor 304, is configured to enable the user to link a plurality of financial accounts to the user account. The account creation module 312, executed by the processor 304, is configured to enable the user to create one or more client account and link with the plurality of financial account. The account linking module 312 is configured to verify KYC documents before linking the financial accounts. The service selection module 314, executed by the processor 304, is configured to enable the user to select at least one financial service request, wherein the financial service request includes a money transfer service. The unique code generation module 316, executed by the processor 304, is configured to generate a unique code comprising details of the user account, wherein the code is at least one of unique ID, QR code, and link. The financial service execution module 320, executed by the processor 304, is configured to executed at least one financial service request utilizing the unique code.

In one embodiment, if the at least one financial service request is a fund transfer account, the system enables the user to send funds from the user account created by the platform. In another embodiment, the system enables the user to send funds from the source account such as a bank account. In another embodiment, the as a default the system always check user account balance for funds first before pulling funds from the linked source account. This will ensure that if funds are available in user account, funds could be instantly transferred to the intended recipient. The account management module 322, executed by the processor 304, is configured to manage one or more accounts created and linked by the user.

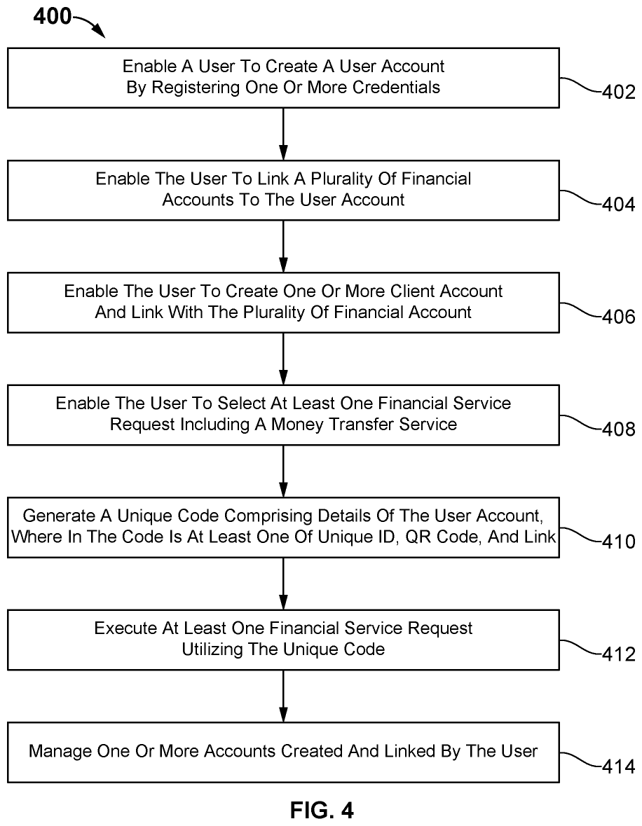

FIG. 4 exemplarily illustrates a flowchart of a method 400 for managing fund transfers according to an embodiment of the present system. The method 400 for managing fund transfer, incorporated in a system comprising one or more processors, and a memory coupled to the one or more processors, wherein the memory stores set of program modules executable by the one or more processors to implement a fund transfer management platform. The method 400 comprises a step 402 of enabling, at the processor, via a registration module, a user to create a user account by registering one or more credentials. The method 400 further comprises a step 404 of enabling, at the processor, via an account linking module, the user to link a plurality of financial accounts to the user account. The method 400 further comprises a step 406 of enabling, at the processor via an account creation module, the user to create one or more client account and link with the plurality of financial account.

The method 400 further comprises a step 408 of enabling, at the processor, a service selection module, the user to select at least one financial service request, wherein the financial service request comprises a money transfer service. The method 400 further comprises a step 410 of generating, at the processor, via a unique code generation module, a unique code comprising details of the user account, wherein the code is at least one of unique ID, QR code, and link. The method 400 further comprises a step 412 of executing, at the processor, via a financial service execution module, at least one financial service request utilizing the unique code. The step 404 further comprises verifying, at the processor, via the account linking module, KYC documents before linking the financial accounts. The method 400 further comprises a step 414 of managing, at the processor, via an account management module, one or more accounts created and linked by the user.

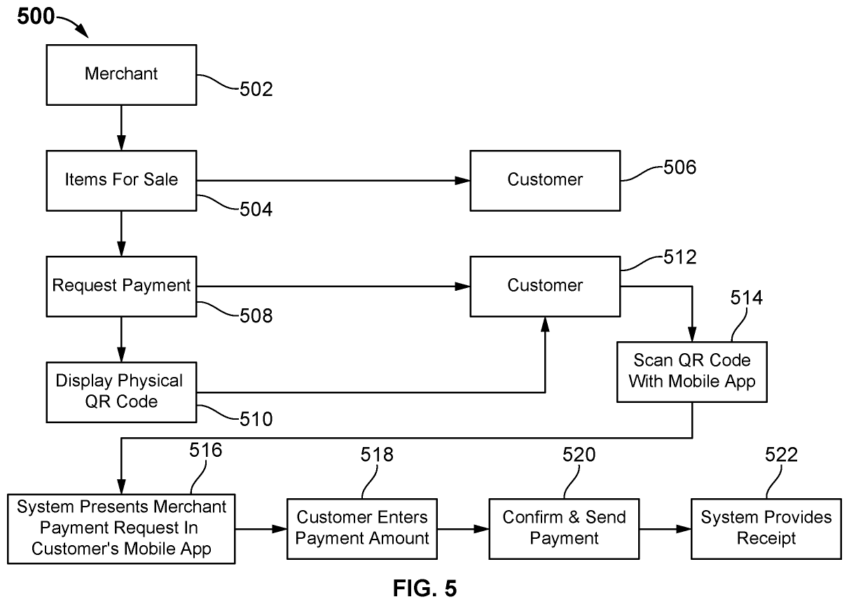

FIG. 5 exemplarily illustrates a use case model 500 of physical merchant 502 utilizing the fund transfer system according to an embodiment of the present system. In this model, the merchant 502 provides one or more items for sale 504. The customer 506, 512 selects one or more preferred items of sale 504. On selection of items for purchase, the system is configured to generate a payment request 508 and a QR code. The QR code comprises the payment request is displayed 510 to the customer. On scanning the QR code 514, the system is configured to present merchant payment request to the customer 516. The system is configured to enable the customer to enter the payment details 518 and is further configured to confirm and send payment to the merchant 520 and provide a receipt to the user 522.

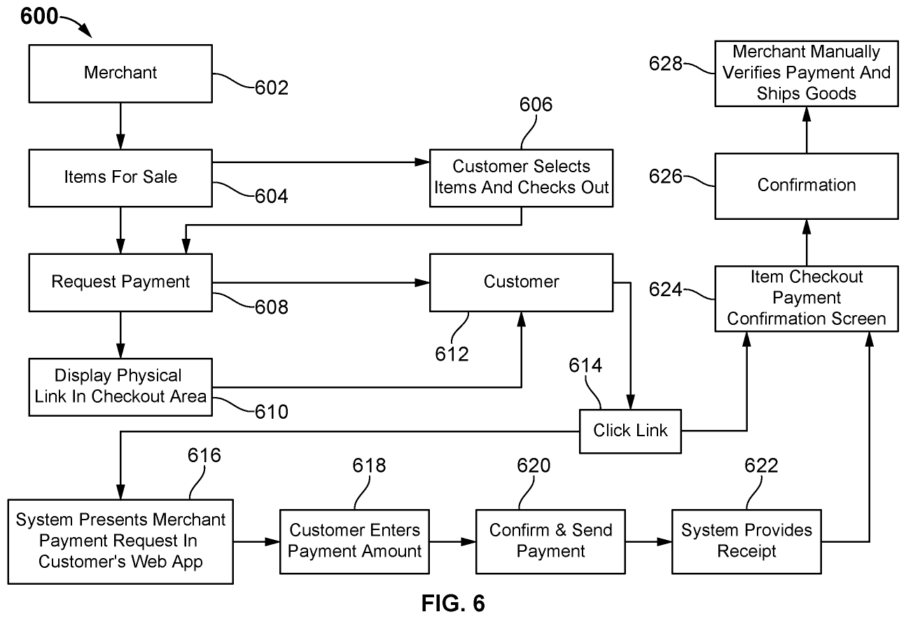

With reference now to FIG. 6, a use case model of online merchant using unique link for fund transfer according to an embodiment of the present system is shown generally at 600. In this model, the merchant 602 provides one or more items for sale 604 over a network. The customer, using a customer device, selects one or more preferred items and proceeds for payment 606. On proceeding for payment by the customer 612, the system is configured to generate a payment request 608 and a unique one-time usage link (although in embodiments it may comprise a QR code). The link comprises a payment request displayed 610 to the customer to proceed with the checkout. Upon clicking the link or QR code 614, the system is configured to present the merchants payment request in the customers application 616 and enable the user to enter the payment amount 618 required for the purchase of one or more selected items. The system is further configured to enable the user the to confirm and initiate the payment process 620 and provide the receipt to the user or customer 622. The system is further configured to provide details regarding the completed payment by the customer to the merchant 624, 626. The merchant may manually verify the payment and ship goods or items to the customer 628.

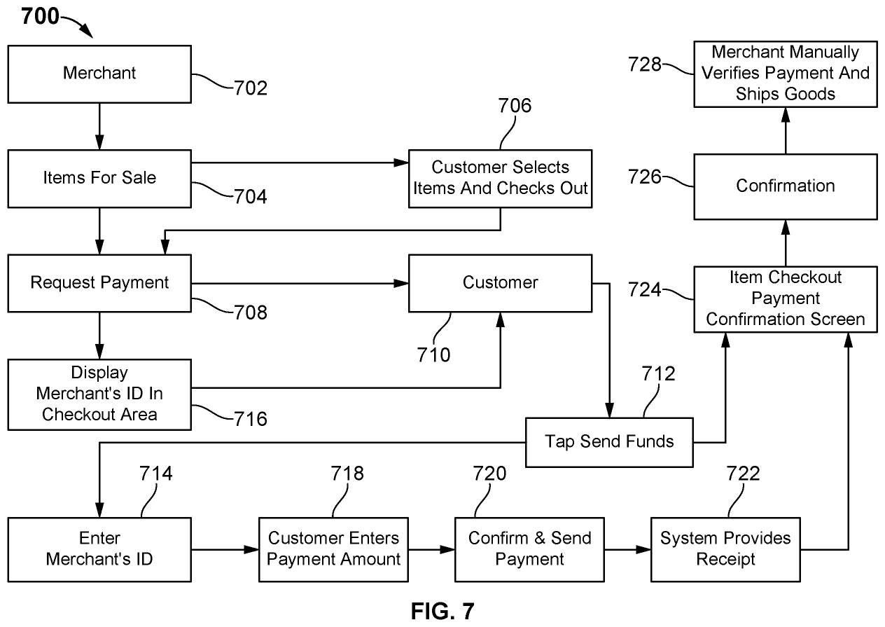

With reference now to FIG. 7, a use case model 700 of online merchant using unique ID for fund transfer according to an embodiment of the present system. In this model 700, the merchant 702 has a merchant device for the one or more items for sale 704. The customer 710 has a customer device and selects one or more preferred items 706 and proceeds for payment. For proceeding for payments by the customer, the system is configured to generate a payment request 708 and a unique one-time usage unique ID. The unique ID comprises a payment request which is displayed 716 to the customer to proceed with the checkout 712. Upon entering the unique ID 714 in the web application installed in the customer device, the system is configured to present merchants payment request in the customer's web application. The system is configured to enable the user to enter the payment amount 718 required for the purchase of one or more selected items. The system is further configured to enable the user the to confirm and initiate the payment process 720. Upon completion of the payment transfer or fund transfer, the system is configured to provide the receipt to the user or customer 722. The system is further configured to provide details regarding the completed payment by the customer to the merchant 724, 726. In embodiments, the merchant may manually verify the payment and ship goods or items to the customer 728.

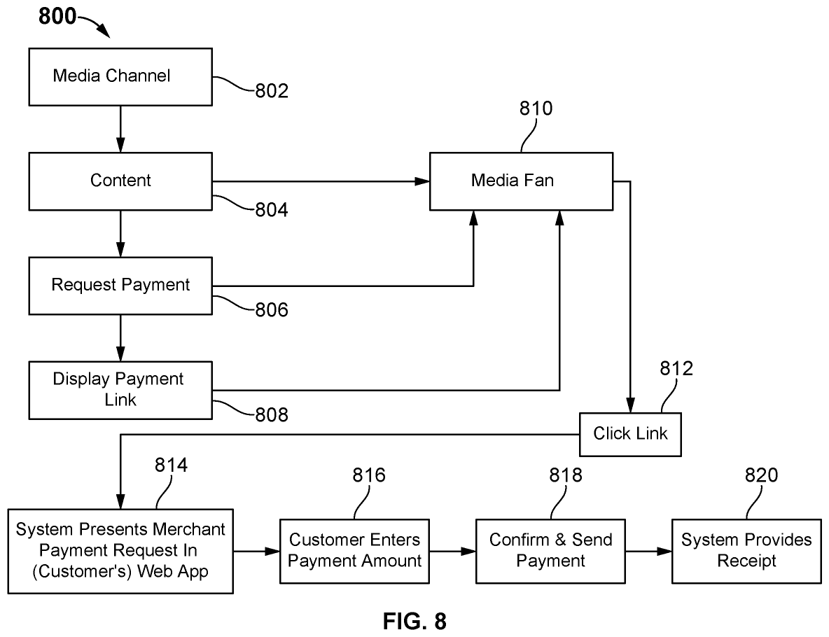

FIG. 8 is an exemplary embodiment illustrating a use case model 800 of content creator using computing device such as smart phone to accept fund transfers from viewers or fan 810 according to an embodiment of the present system. In this exemplary embodiment, the content creator has media/content 804 on YouTube® 802, and a user is interested in viewing and/or supporting the media (e.g., a show). In this model, a media device is associated with a content creator. In embodiments, the content creator may request payment 806 for viewership, and the viewer may use a displayed unique link 805 to pay fee. In other embodiments, the payment be of any type whether it be a fee, a donation, or the like. In operation, upon expressing interest on the content, the system is configured to generate a link and a payment request 814, where customer enters payment amount 816. The system is further configured to confirm and send payment 818 to the content creator and provides a receipt 820 to the user, whilst in some embodiments unlocking special features of the media.

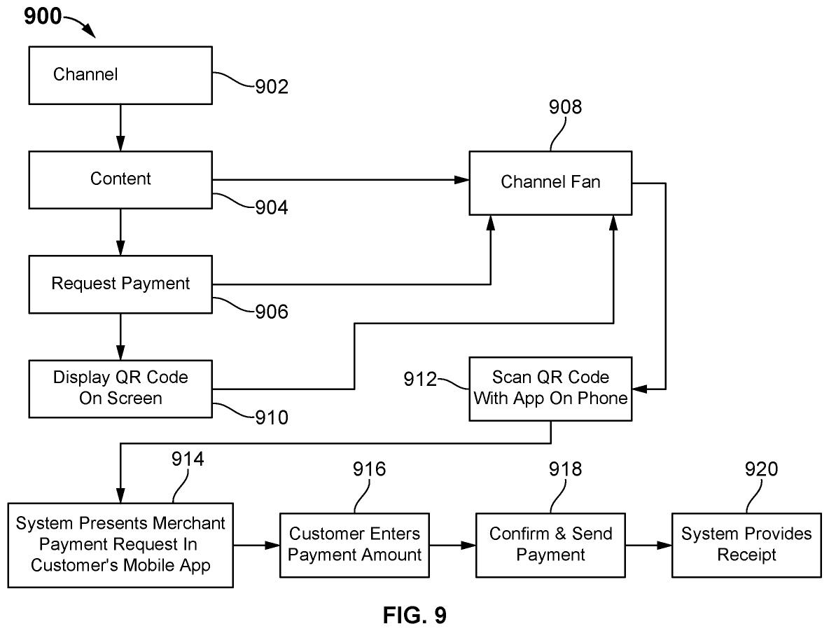

FIG. 9 exemplarily illustrates a use case model 900 of content creator using computing devices such as smart phone to accept and transfer funds like in case 800, but in this case using a QR code according to an embodiment of the present system. In operation, the content creator/YouTube channel 902 posts a content 902 in a website such as YouTube®. In the native system, the user wants to access additional content or pay for premium, the system generates a QR code that is shown in the media. The user may then use the QR code to payment request 906 and the system displays the QR code on screen 910. The user scans QR code with an application on the phone 912. The system presents merchant payment request in customers mobile application 914. The system is further configured enable the user to enter payment amount 916 and to confirm and send payment 918 to the content creator, and provides a receipt 920 to the user.

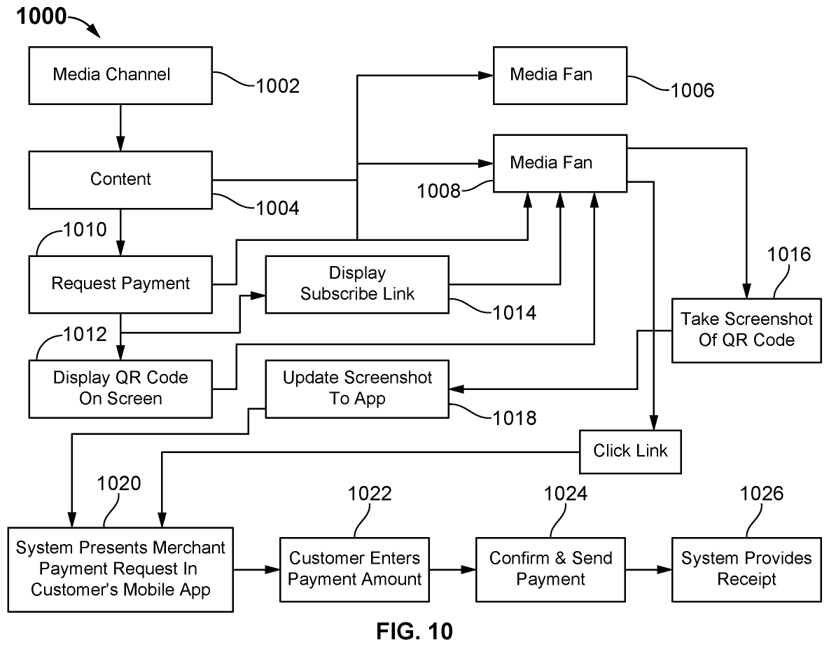

FIG. 10 exemplarily illustrates a use case model 1000 of content creator using a smartphone to accept transfers of funds like in cases 800 and 900, but in this case, additional options are provided to the user for subscription. Upon expressing interest on the content 1004 of a YouTube channel 1002 by a YouTube fan 1006, 1008, the system is configured to generate a payment request 1010 and a unique code on the media screen. Further, the system is configured to display a subscribe link to the user 1014. In one embodiment, the unique code is a QR code, and the subscription option is a link. If the system provides a QR code 1012, the user could either scan the code or take screenshot of the code 1016 and upload to the web application in the mobile device 1018. On executing either one disclosed action, the system is configured to present the payment request to the user 1020. The system is configured to enable the user to enter the payment details 1022. The system is further configured to confirm and send payment to the content creator 1024 and provides a receipt to the user 1026.

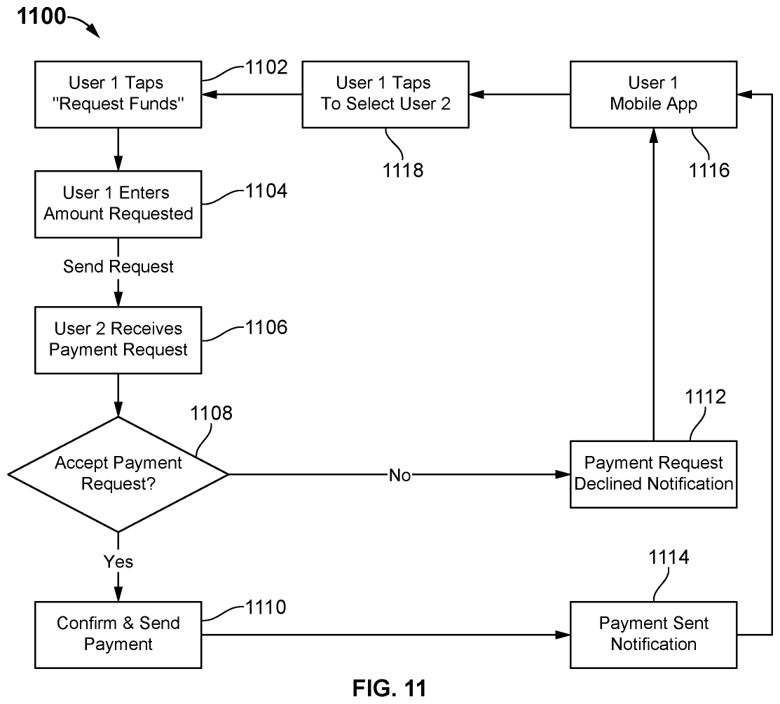

Referring now to FIG. 11 a use case model 1100 of peer-to-peer fund request is shown according to an embodiment of the present system. In this model 1100, the fund transfer system is in communication with a first user device and a second user device. The first user device is associated with a first user and the second user device associated with a second user.in this embodiment, the first user selects a financial service “request funds” 1102 from second user 1118. Then, the system prompts the first user to enter a value 1104. The system is configured to send the payment request to the second user 1106. The second user may either accept the payment request or reject the payment request 1108. On rejecting the payment request, the system is configured to send a notification 1112 to the first user 1116 stating that the payment request is rejected. On accepting the payment request, the second user sends the requested amount to the first user. On successful completion of payment 1110, a notification 1114 is sent to the second user and first user by the system.

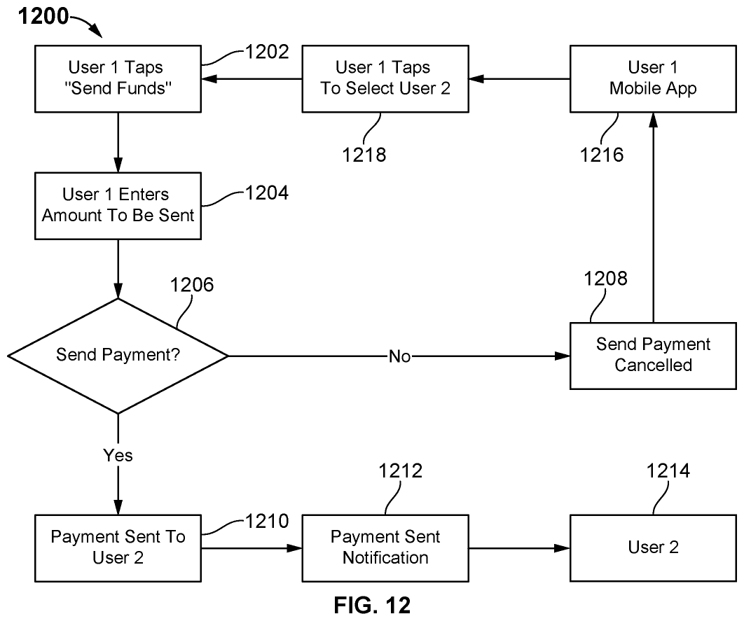

FIG. 12 exemplarily illustrates a use case model 1200 of peer-to-peer fund transfer request, according to an embodiment of the present system. In this model, the fund transfer system is in communication with a first user device and a second user device. The first user device is associated with a first user and the second user device associated with a second user. The first user wishes to transfer funds to the second user. The first user selects second user 1218 and a financial service “send funds” 1202. Then, the system prompts the first user to enter a value of amount need to be sent 1204. Then, the system prompts the user to confirm the fund transfer request or transaction 1206. If the first user rejects the transaction, the financial service initiated by the first user would be cancelled 1208, 1216. If the first user allows transaction, the funds are transferred to the second user 1210 and a notification 1212 is sent to the second user 1214 regarding the transaction.

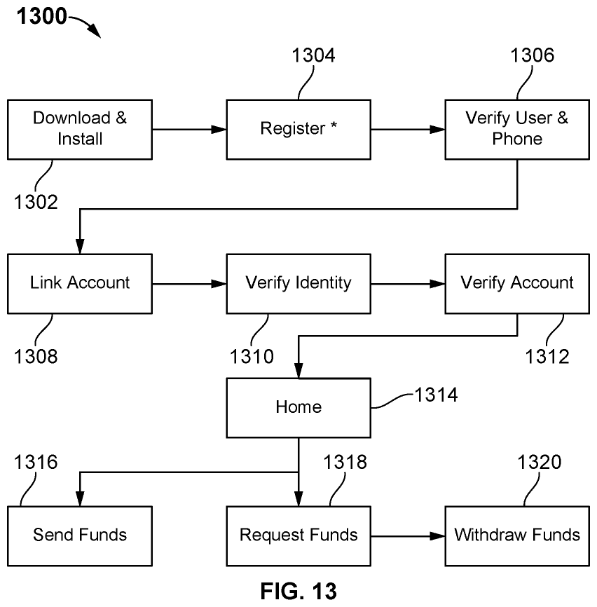

FIG. 13 exemplarily illustrates a block diagram 1300 of top-level view of financial platform of the fund transfer system according to an embodiment of the present system. In one embodiment, the fund transfer system is in communication with a user device. The user device is associated with the user. The user device is installed with the fund transfer system 1302 The fund transfer system comprises one or more processors, and a memory coupled to the one or more processors, wherein the memory stores set of program modules executable by the one or more processors. The set of program modules comprises a registration module, account linking module and a service selection module. The registration module is configured to enable a user to input one or more credentials for registration 1304. In one embodiment, the credentials include first name, last name, email address, phone number and password. The registration module is configured to verify 1306 the one or more credentials entered by the user. The account linking module is configured to enable a user to link a plurality of financial accounts 1308. The account linking module is further configured to verify the identity 1310 of the linked account 1312. The service selection module is configured to enable a user to select at least one financial service request from home screen 1314, wherein the financial service request comprises a money transfer service, send funds 1316, request funds 1318 and withdraw funds 1320.

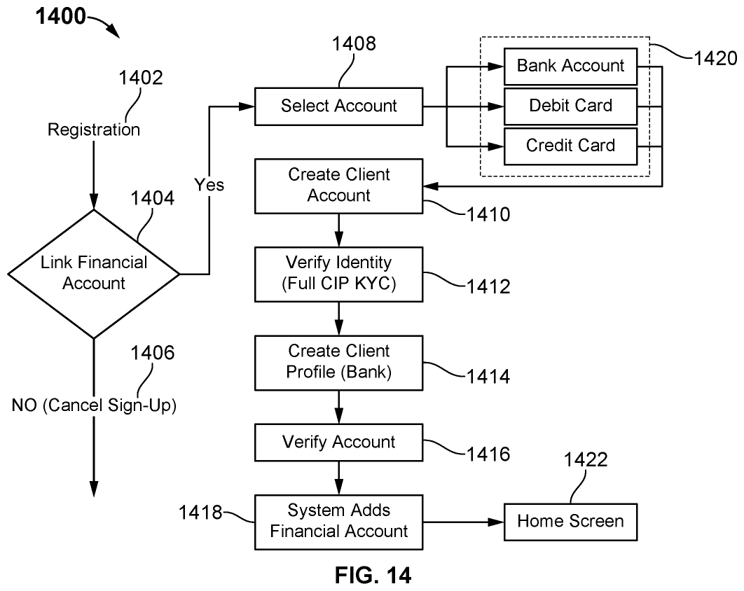

FIG. 14 exemplarily illustrates a method 1400 of linking financial accounts according to an embodiment of the present system. In one embodiment, the fund transfer system is in communication with a user device. The fund transfer system comprises one or more processors, and a memory coupled to the one or more processors, wherein the memory stores set of program modules executable by the one or more processors. The set of program modules comprises a registration module, and account linking module. The registration module is configured to enable a user to input one or more credentials for registration 1402 and account creation. After registration, the user is prompted to link one or more financial accounts 1404 or the user may cancel sign-up 1408. If the user accepts to link financial account, the account linking module is configured to prompt the user to select at least financial account 1408. In one embodiment, the financial account is at least one of bank account, debit card or credit card 1420. The account linking module configured to enable to create client account 1410. The account linking module is further configured to verify the KYC document 1412 to verify the identity of the account 1416. Upon verifying the bank account, client profile is created 1414 and the financial account is added to the user account 1418 to the home screen 1422.

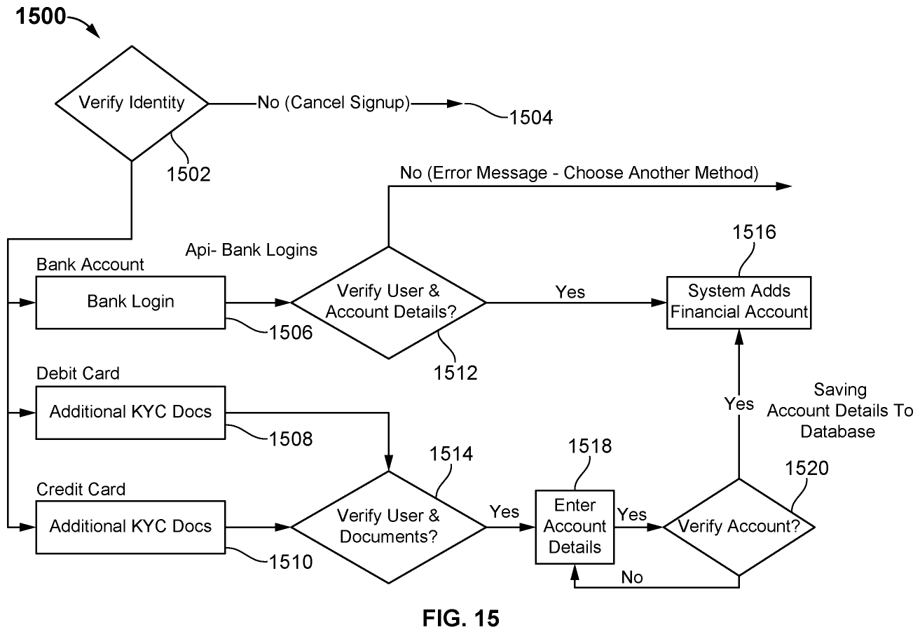

FIG. 15 is an exemplarily illustration of a method 1500 to verify of user identity, according to an embodiment of the present system. On registration, the user identity is verified 1502. The user may also cancel signup 1504. If the users linked financial is a bank account 1506, the account linking module is configured to verify user details and account details 1512. If he linked financial is at least one of debit card or credit card 1508, 1510, the account linking module is configured to verify user and document details 1514. Then the user is configured to enter account details 1518 of the card for further verification 1520. Once verification is successful, the financial accounts are added to the user account 1516.

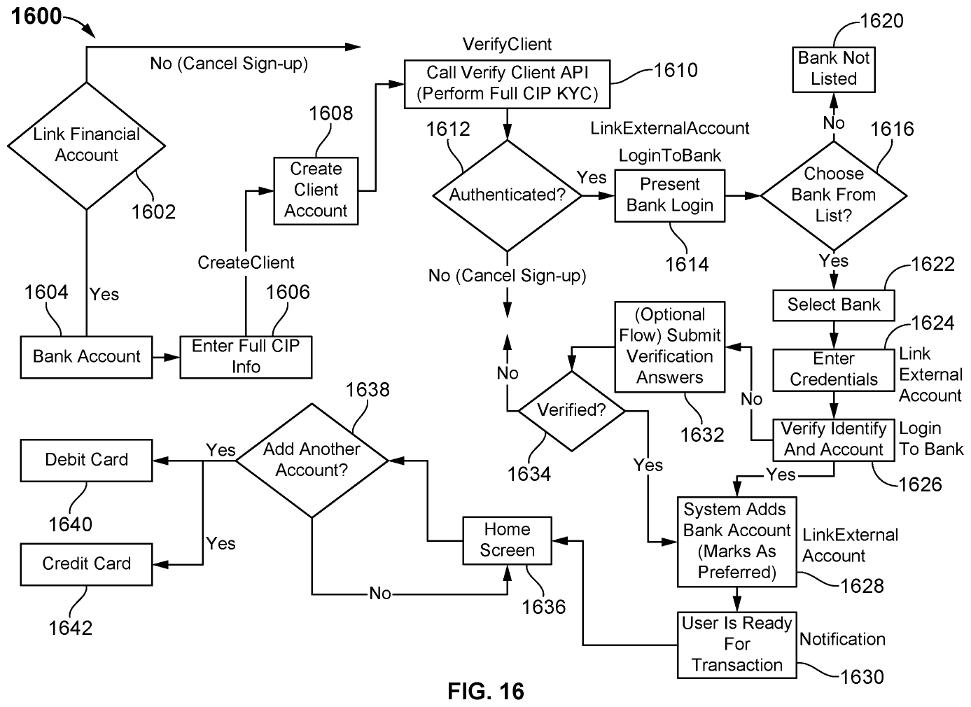

FIG. 16 exemplarily illustrates a method 1600 of linking financial account, according to an embodiment of the present system. From step 1602 to step 1640, the system enables the user to create client account and verifies the client identity using KYC documents, and after verification, the system enables to link the account with the user bank account.

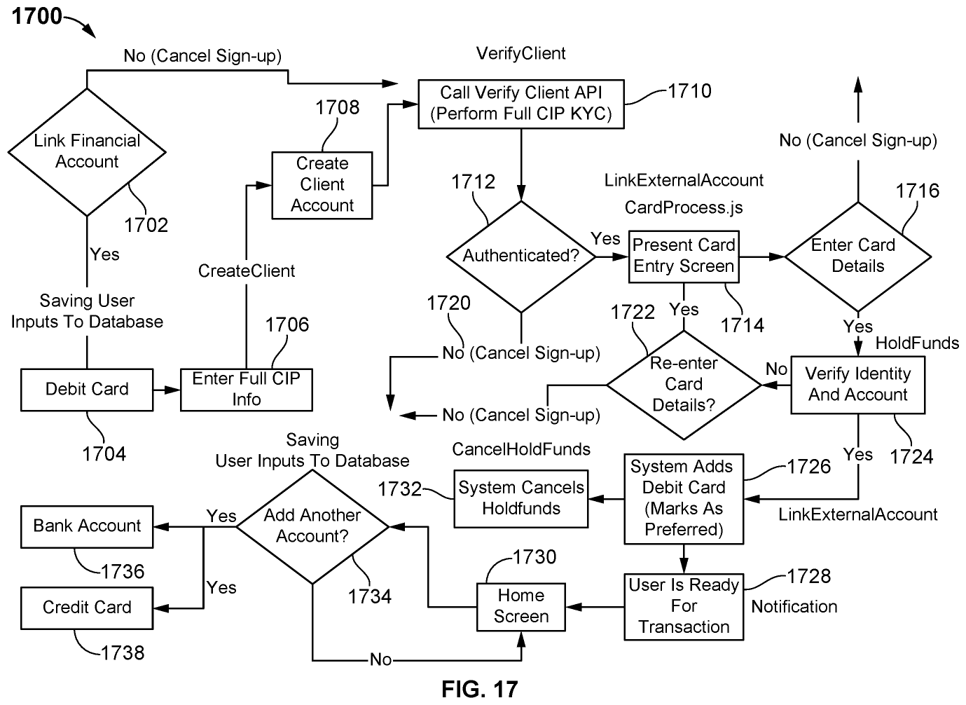

FIG. 17 exemplarily illustrates a method 1700 of linking financial account such as debit card, according to an embodiment of the present system. From step 1702 to step 1736, the system enables the user to create client account and verifies the client identity using KYC documents, and after verification, the system enables to link the account with the user's credit card and/or debit card.

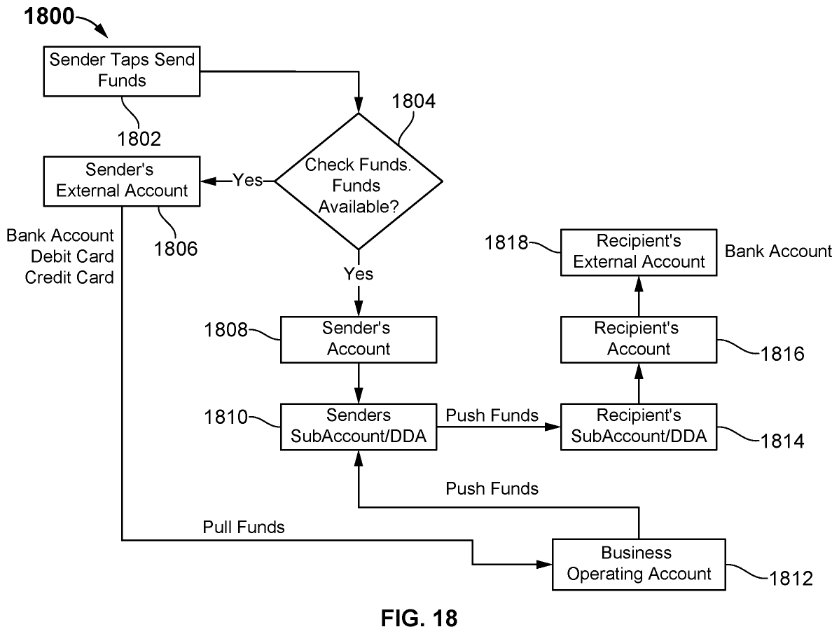

FIG. 18 exemplarily illustrates a method 1800 of transferring funds according to an embodiment of the present system. In one embodiment, the present system comprises a sender device associated with a sender, a receiver device associated with a receiver is in communication with the fund transfer system. The sender selects a financial service “send requests” 1807 and the system is configured to check fund availability 1804. If the funds are available at the senders external account 1806 such as bank account, debit card or credit card or sender's account 1808, the system is configured to transfer funds to the receiver from the external account. If the funds are available at the wallet of the user account, the system is configured to transfer funds to the receiver from the wallet. The funds are pushed through business operating account 1812, sender's subaccount/DDA 1810, recipients subaccount/DDA 1814, recipient account 1816 in the fund transfer system or wallet and finally to the recipient's external account 1818.

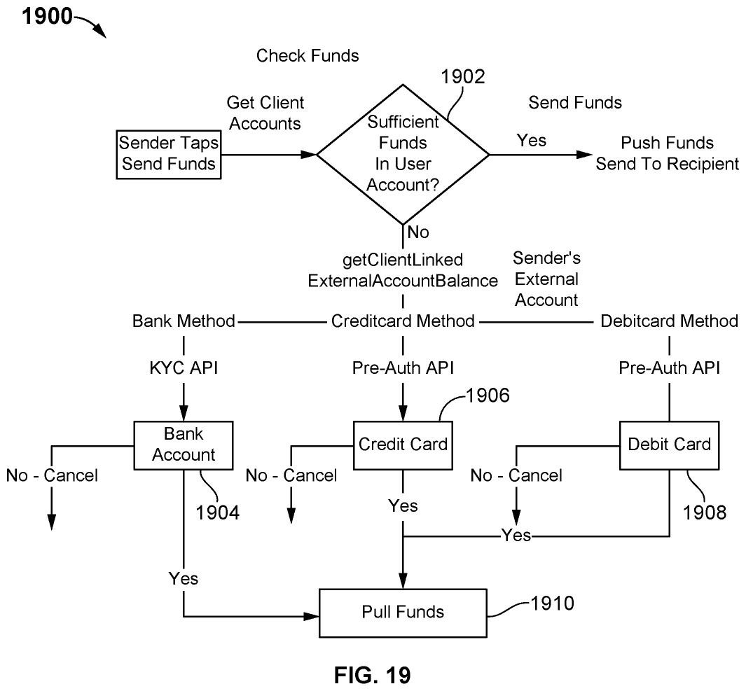

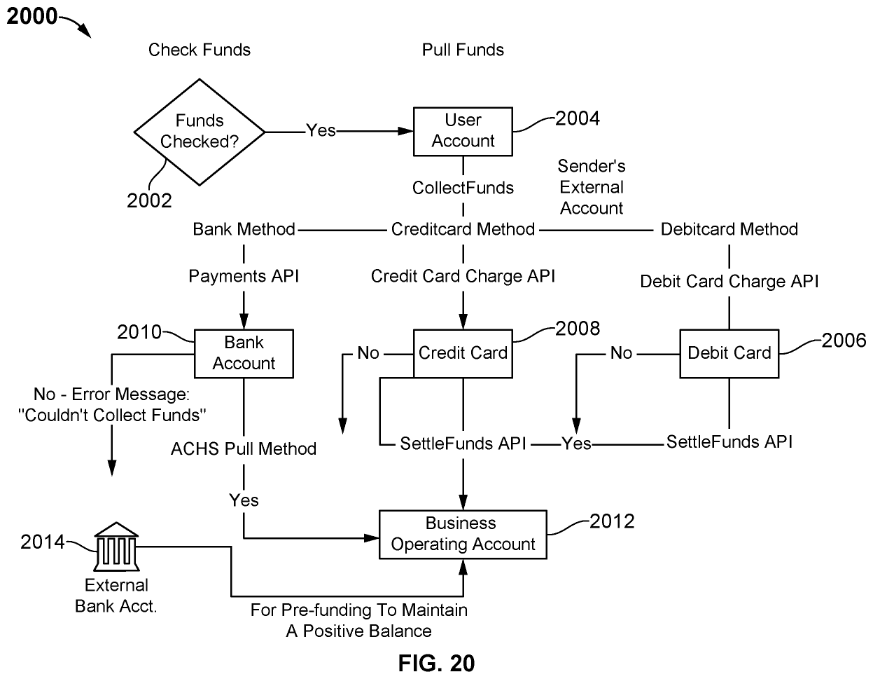

FIG. 19 exemplarily illustrates a method 1900 of checking availability of funds according to an embodiment of the present system. The system checks for finds in user account 1902 such as bank account 1904, credit card 1906, and debit card 1908 to pull funds 1910. FIG. 20 exemplarily illustrates a method 2000 of checking availability of funds and transferring funds from an external account according to an embodiment of the present system. The fund transfer system is configured to check for funds 2002 in linked user account 2004 such as bank account 2010, credit card 2008 and debit card 2006. If funds are not available, the process ends. If the funds are available, the fund transfer system is configured to push funds from the sender's account to the receiver's account. Referring to FIG. 20, the if the funds are available at the external account, the system connects the business operating account 2012 of the fund transfer system to the external bank account 2014 for pre-funding to maintain a positive balance.

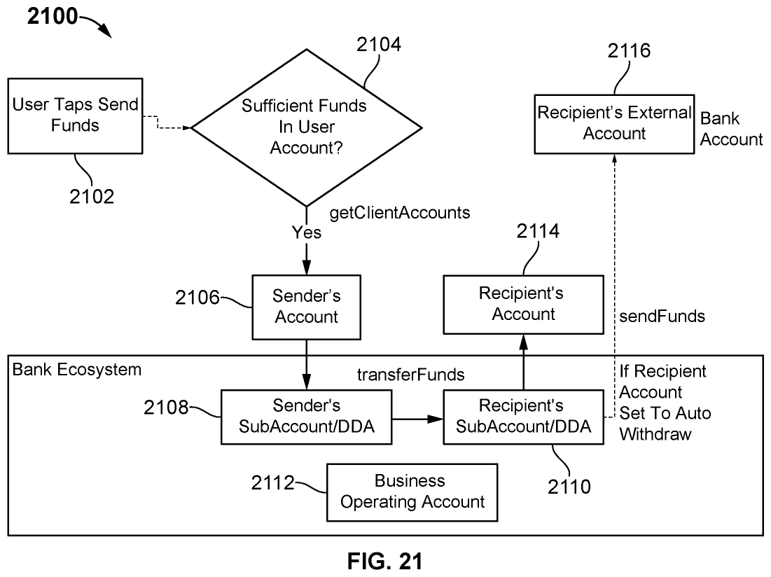

FIG. 21 exemplarily illustrates a method 2100 of transferring funds according to another embodiment of the present system. The fund transfer system of the present system is in communication with the bank ecosystem including sender's subaccount/DDA, recipient's subaccount/DDA, business operating account of fund transfer system. The user selects “fund transfer” financial service 2102. The system checks for availability of fund in the user account created by the fund transfer system for transaction 2104. If yes, from the user account or sender account 2106 of the fund transfer system, funds are transferred to the receiver account of the fund transfer system, via sender's subaccount/ DDA 2108, business operating account 2112 and recipient's subaccount/DDA 2110. If the recipient account is set to auto withdraw, the funds are transferred to the recipient's external account 2114 or recipients external account 2116.

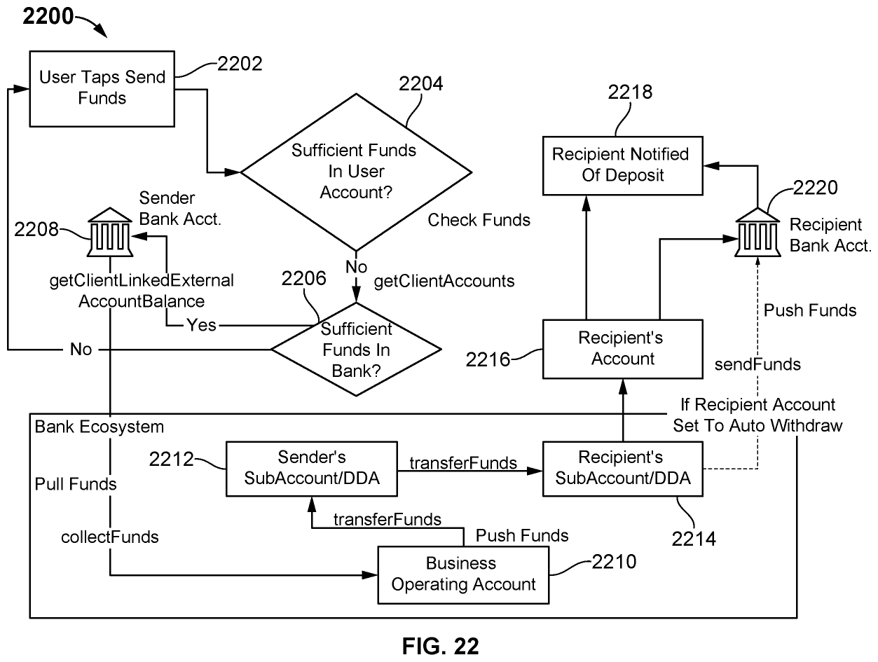

FIG. 22 illustrates an exemplary method 2200 of transferring funds from bank to bank, according to an embodiment of the present system. The fund transfer system of the present system is in communication with the bank ecosystem including sender's subaccount/DDA, recipient's subaccount/DDA, business operating account of fund transfer system. The user selects “fund transfer” financial service 2202. The system checks for availability of fund in the user account created by the fund transfer system for transaction 2204, 2206. If yes, from the sender bank account, 2208 funds are transferred to the receiver account 2216 of the fund transfer system, via business operating account 2210, sender's subaccount/ DDA 2212, and recipient's subaccount/DDA 2214. If the recipient account is set to auto withdraw, the funds are transferred to the recipient's external bank account 2220 and the recipient is notified of the deposit 2218.

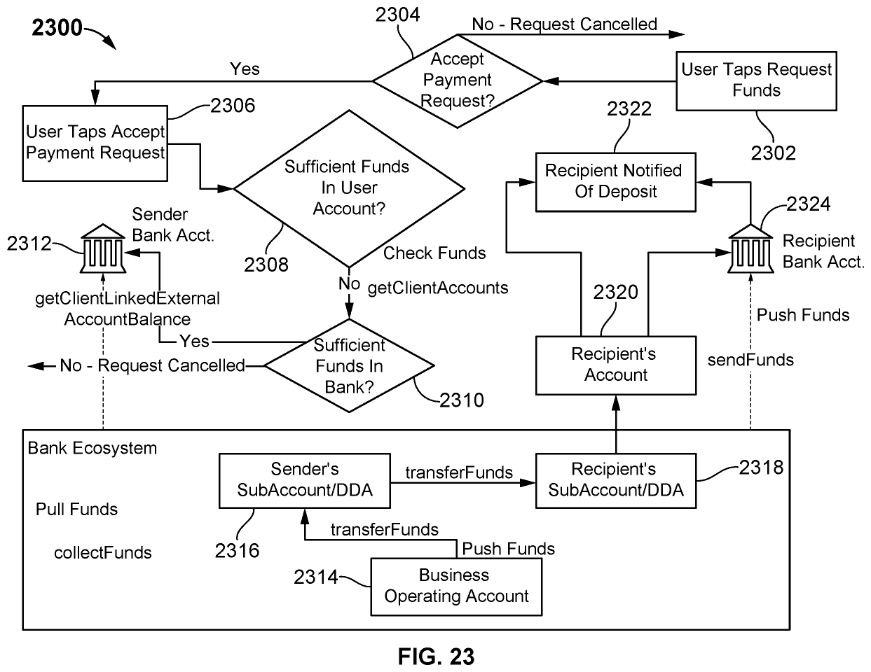

FIG. 23 illustrates an exemplary method 2300 of requesting funds from bank to bank according to an embodiment of the present system. The system enables the user to request fund from another user or sender 2302. If the transferor accepts the request 2304, 2306, the system checks for availability of fund in the sender or user account 2308 or bank account 2310 created by the fund transfer system for transaction. If yes, from the sender credit/debit card/sender bank account 2312, funds are transferred to the recipient bank account 2324 via a receiver account 2320 of the fund transfer system, via business operating account 2314, sender's subaccount/DDA 2316, and recipient's subaccount/DDA 2318. If the recipient account is set to auto withdraw, the funds are transferred to the recipient's external/bank account 2324 and recipients is notified of deposit 2322.

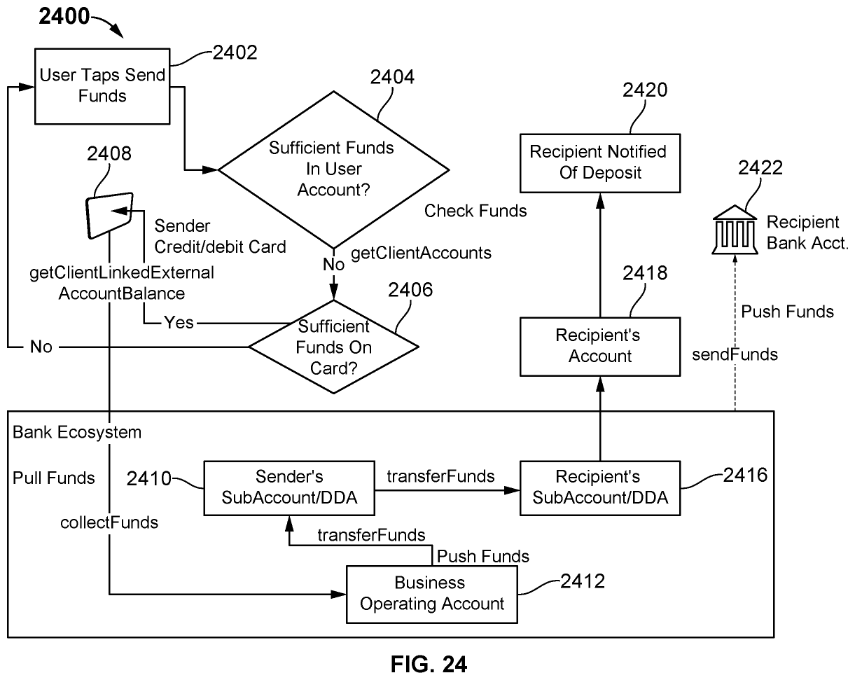

FIG. 24 illustrates an exemplary method 2400 of transferring funds from external account such as credit card, debit card to bank according to an embodiment of the present system. The fund transfer system of the present system is in communication with the bank ecosystem including sender's subaccount/DDA, recipient's subaccount/DDA, business operating account of fund transfer system. The user selects “fund transfer” financial service 2402. The system checks for availability of fund in the user account 2404 created by the fund transfer system or on cards 2406 for transaction. If yes, from the sender credit/debit card 2408, funds are transferred to the receiver account 2418 of the fund transfer system, via business operating account 2412, sender's subaccount/DDA 2410, and recipient's subaccount/DDA 2416. If the recipient account is set to auto withdraw, the funds are transferred to the recipient's external account 2422. Further, the recipient is notified regarding the deposit 2426.

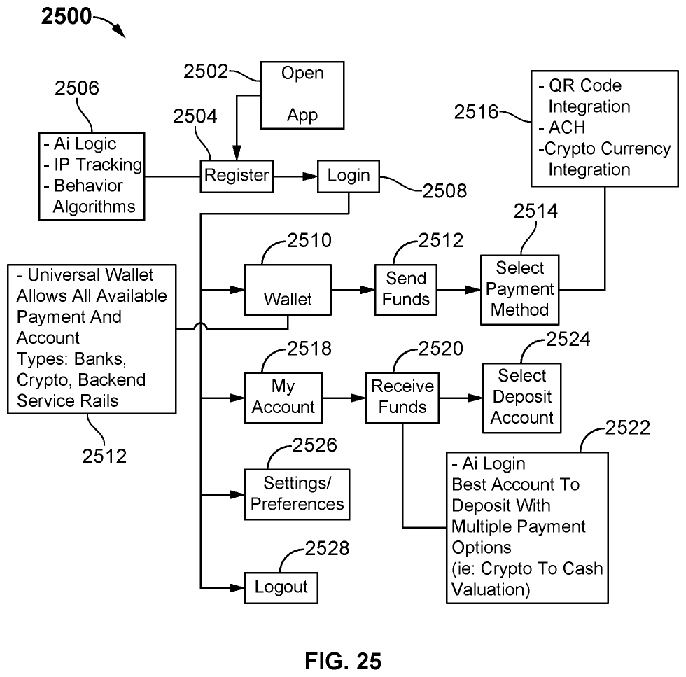

Referring now to FIG. 25, a specialized system platform architecture and data routing scheme diagram is provided generally at 2500. The platform architecture comprises initiating via mobile application 2502 downloadable onto a user device from an application store, for example. A registration module 2504 is provided to collect user information. The registration module is in communication with AU logic module 2506, which tracks user behavior and IP addresses for purposes of security. Once a user logs in at module 2508, a wallet 2510 opens and receives data from the registration and login module. The wallet 2508 is also in communication with security module 2512, which provides the ability to safely allow transfer of funds including but not limited to any account types, banking, crytocurrency, and backend service rails. In operation, the wallet 2510 allows the user to send funds via funds module 2512, then a user may selected a payment method module 2514. The payment method 2514 is in communication with QR code generator which generates or integrates existing QR codes for payment in a virtual space, and integrates a cryptocurrency exchange or send/receive USD or toher currency via ACH.

Account module 2518 automatically communicates with certain banking portals to link accounts, and the receive payment module 2520. Integrally, the receive payment module utilizes machine learning and artificial intelligence via AI module 2522 to choose which type of account is the proper account for the funds depending upon a variety of factors, including but not limited to type of currency, source of payment, user history, or any combination thereof. Deposit module then 2524 receives the payment. The system further comprises settings module 2526 and logout module 2528.

Preferred embodiments of this invention are described herein, including the best mode known to the inventors for carrying out the invention. It should be understood that the illustrated embodiments are exemplary only and should not be taken as limiting the scope of the invention.

Although specific features of various embodiments of the invention may be shown in some drawings and not in others, this is for convenience only. In accordance with the principles of the invention, the feature(s) of one drawing may be combined with any or all of the features in any of the other drawings. The words “including,” “comprising,” “having,” and “with” as used herein are to be interpreted broadly and comprehensively, and are not limited to any physical interconnection. Moreover, any embodiments disclosed herein are not to be interpreted as the only possible embodiments. Rather, modifications and other embodiments are intended to be included within the scope of the appended claims.

1. A system for managing fund transfers, comprising:
one or more processors, and
a memory coupled to the one or more processors, wherein the memory stores set of program modules executable by the one or more processors to implement a fund transfer management platform;
a registration module to enable a user to create a user account by registering one or more credentials, via a user device, wherein the user device accesses the fund transfer management platform via a network;
an account linking module to enable the user to link a plurality of financial accounts to the user account;
a service selection module to enable the user to select at least one financial service request, wherein the financial service request comprises a money transfer service;
a unique code generation module to generate a unique code comprising details of the user account, wherein the code is at least one of unique ID, QR code, and link; and
a financial service execution module to execute at least one financial service request utilizing the unique code.

2. The system of claim 1, wherein the financial service is a cryptocurrency request or cryptocurrency payment.

3. The system of claim 1, further comprising an account creation module to enable the user to create one or more client account and link with the plurality of financial account, wherein the account linking module is configured to verify KYC documents before linking the financial account.

4. The system of claim 1, further comprising an account management module to manage one or more accounts created and linked by the user.

5. The system of claim 1, wherein the user is at least one of a fund transferor or fund transferee.

6. The system of claim 1, wherein the financial service further comprises scan and payment request, send payment request and accept payment request.

7. The system of claim 1, wherein the financial accounts comprises a bank account, a credit card, a debit card and a wallet.

8. The system of claim 1, wherein the fund transferee is at least one of merchant, media subject or individual.

9. The system of claim 1, wherein the user device is at least one of a desktop, a laptop, a tablet, a mobile phone, and mobile or a handheld electronic device.

10. The system of claim 1, wherein the network is at least one of Wi-Fi network, WiMax network, and wireless local area network.

11. A method for managing fund transfer, incorporated in a system comprising one or more processors, and a memory coupled to the one or more processors, wherein the memory stores set of program modules executable by the one or more processors to implement a fund transfer management platform, comprising the steps of:
enabling, at the processor, via a registration module, a user to create a user account by registering one or more credentials, via a user device, wherein the user device accesses the fund transfer management platform via a network;
enabling, at the processor, via an account linking module, the user to link a plurality of financial accounts to the user account;
enabling, at the processor, via an account creation module, the user to create one or more client account and link with the plurality of financial account;
enabling, at the processor, a service selection module, the user to select at least one financial service request, wherein the financial service request comprises a money transfer service;
generating, at the processor, via a unique code generation module, a unique code comprising details of the user account, wherein the code is at least one of unique ID, QR code, and link; and
executing, at the processor, via a financial service execution module, at least one financial service request utilizing the unique code.

12. The method of claim 11, further comprises a step of: verifying, at the processor, via the account linking module, KYC documents before linking the financial accounts.

13. The method of claim 11, further comprises a step of: managing, at the processor, via an account management module, one or more accounts created and linked by the user.

14. The method of claim 11, wherein the credentials comprises first name, last name, email address, phone number and password.

15. The method of claim 11, wherein the user is at least one of a fund transferor or fund transferee.

16. The method of claim 11, wherein the financial service further comprises scan and payment request, send payment request and accept payment request.

17. The method of claim 11, wherein the financial accounts comprises a bank account, a credit card, a debit card and a wallet.

18. The method of claim 11, wherein the fund transferee is at least one of merchant, media subject or individual.

19. The method of claim 11, wherein the user device is at least one of a desktop, a laptop, a tablet, a mobile phone, and mobile or a handheld electronic device.

20. The method of claim 11, wherein the network is at least one of Wi-Fi network, WiMax network, and wireless local area network.
